(19) United States
(12) Patent Application Publication
(10) Pub. No.: US 2005/0247330 A1
(43) Pub. Date: Nov. 10, 2005

(54) Liquid presence sensor

(75) Inventors: Donald O. Land, Lake Clarke Shores, FL (US); Kim Chun Chiu, Kowloon (HK)

Correspondence Address: HARRINGTON & SMITH, LLP, 4 RESEARCH DRIVE, SHELTON, CT, 06484-6212, US

(73) Assignee: HP Intellectual Corp.

(21) Appl. No.: 11/117,246

(22) Filed: Apr. 27, 2005

Related U.S. Application Data
(60) Provisional application No. 60/566,748, filed on Apr. 30, 2004.

(51) Int. Cl. B08B 3/00; B08B 13/00

(52) U.S. Cl. 134/113; 340/603

(57) ABSTRACT

In an embodiment of the invention, a system for detecting a presence of a liquid in an ultrasonic frequency device is formed of a first electrode coupled to a voltage source and extending into a fluid reservoir of the ultrasonic device, a second electrode separated from the first electrode by a fluid gap, coupled to a common circuit point, and extending into the fluid reservoir, a first resistor in series with the voltage source and the first electrode, a voltage sensor coupled to a junction between the first resistor and the first electrode for sensing a voltage at the junction, and an apparatus for comparing the sensed voltage to a threshold voltage to determine a presence of a fluid within the fluid reservoir.

### CROSS REFERENCE TO RELATED APPLICATION

This patent application claims priority under 35 U.S.C. §119(e) from Provisional Patent Application No. 60/566,748, filed 30 Apr. 2004, the disclosure of which is incorporated by reference herein in its entirety.

### TECHNICAL FIELD

This invention relates generally to liquid presence sensors and, more specifically, relates to liquid presence sensors in a cleaning appliance.

### BACKGROUND

There are numerous applications that require the sensing of a liquid level in a container, and numerous methods for sensing the level or amount of the liquid in a container. Typical liquid level sensing devices include electrostatic capacitance type liquid-level sensing devices, barometric liquid-level sensing devices, float type liquid-level sensing devices, electrode type liquid-level sensing devices and electric wave type liquid-level sensing devices.

U.S. Pat. No. 6,376,444 B1 discloses a garment stain removal product which uses sonic or ultrasonic waves. There is a desire to provide a new type of cleaning device which comprises an ultrasonic cleaning system with a liquid presence sensor.

The presence or absence of cleaning fluid is desired in a cleaning appliance that both dispenses cleaning fluid, and uses electromechanical means for cleaning an external object.

### SUMMARY OF THE PREFERRED EMBODIMENTS

The foregoing and other problems are overcome, and other advantages are realized, in accordance with the embodiments of these teachings.

The invention provides a system and method that includes a circuit to determine the presence or absence of a fluid using the resistance of the fluid segment.

The invention can be utilized with fluid having a conductivity that is not extremely high and can be predicted to be known within a certain broad range. The resistance of a fixed length segment of the fluid transport channel is used to determine the presence or absence of fluid.

In an embodiment of the invention, a system for detecting a presence of a liquid in an ultrasonic frequency device comprises a first electrode coupled to a voltage source and extending into a fluid reservoir of the ultrasonic device, a second electrode separated from the first electrode by a fluid gap, coupled to a common circuit point, and extending into the fluid reservoir, a first resistor in series with the voltage source and the first electrode, a voltage sensor coupled to a junction between the first resistor and the first electrode for sensing a voltage at the junction, and a system for comparing the sensed voltage to a threshold voltage to determine a presence of a fluid within the fluid reservoir.

In another embodiment of the invention, a cleaning apparatus comprises a reservoir for holding a cleaning fluid, a system for dispensing an amount of the cleaning fluid, a system for emitting an ultrasonic signal at the dispensed cleaning fluid, and a system for detecting a presence of the cleaning fluid in the reservoir.

In another embodiment of the invention, a method for operating an ultrasonic frequency device comprises providing an ultrasonic frequency device having a fluid reservoir extending between a first and a second electrode, applying a voltage across the first and second electrode, measuring a voltage at a junction formed between a resistor and the first electrode the resistor in series with a source of the applied voltage, comparing the measured voltage to a threshold value to determine a presence of a fluid in the ultrasonic frequency device, and controlling the operation of the ultrasonic frequency device in response to the determination of the presence of the fluid.

In another embodiment of the invention, a system for determining the presence of a liquid in an ultrasonic frequency device comprises at least two sensory devices mounted vertically in a channel, a terminal coupled to each of the at least two sensory devices, a wire coupled to each of the terminals, wherein the wire is coupled to an electrode forming a voltage junction, a measuring device for measuring a voltage at the voltage junction, a storage device for storing the measured values; and an analysis device for analyzing the stored values to determine the presence of the liquid in the ultrasonic frequency device.

In another embodiment of the invention, a stain cleaning apparatus is provided comprising a contact surface for contacting an article to be cleaned, and a system for determining the presence of liquid of an ultrasonic frequency device, wherein a resistance is measured in a channel to determine the presence of a liquid for application to the article at the contact surface.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a schematic block diagram of a liquid presence sensor system suitable for practicing the invention;

FIG. 2 is an exploded perspective view according to an embodiment of the liquid presence sensor system of the invention;

FIG. 3 is a side view of the liquid presence sensor system shown in FIG. 2;

FIG. 4 is a cross sectional view of a portion of the liquid presence sensor system shown in FIG. 3;

FIG. 5 is a side view of the liquid presence sensor system shown in FIG. 4;

FIG. 6 is a perspective view of a cleaning device incorporating features of the invention;

FIG. 7 is a schematic block diagram of an embodiment of a liquid presence sensor system of the invention;

FIG. 8 is a schematic block diagram of an embodiment of a liquid presence sensor system of the invention; and

FIG. 9 is a flow chart of a method of the invention.

### DETAILED DESCRIPTION OF THE PREFERRED EMBODIMENTS

The liquid presence sensor described herein operates, in part, upon the principle that the presence of a liquid between two electrodes will result in current flowing between the electrodes and through the fluid when a voltage is applied across the electrodes. Specifically, the resistance of the fluid between the electrodes creates a voltage divider with a fixed reference resistor, the other side of which returns to a voltage source. Two conductive electrodes are inserted into a fluid channel at predetermined points for this purpose. One of the electrodes is electrically connected to a common circuit point, typically ground, and the other electrode is electrically connected to form a junction with the fixed resistor. Measurement of the voltage present at the junction is indicative of whether or not there is fluid present between the electrodes across which current can flow. Measured junction voltages are compared to a threshold value. Measured junction voltages below the threshold value indicate that fluid is present, and voltages above the threshold value indicate that fluid is not present. The fluid path is designed such that residual fluid will drain from between the electrodes when all available fluid has been dispensed while the electrodes are placed in such a way as to not trap gas bubbles in the flow channel. The electrodes are plated with a stable metal, preferably gold, in order to reduce oxidation or the accumulation of deposits.

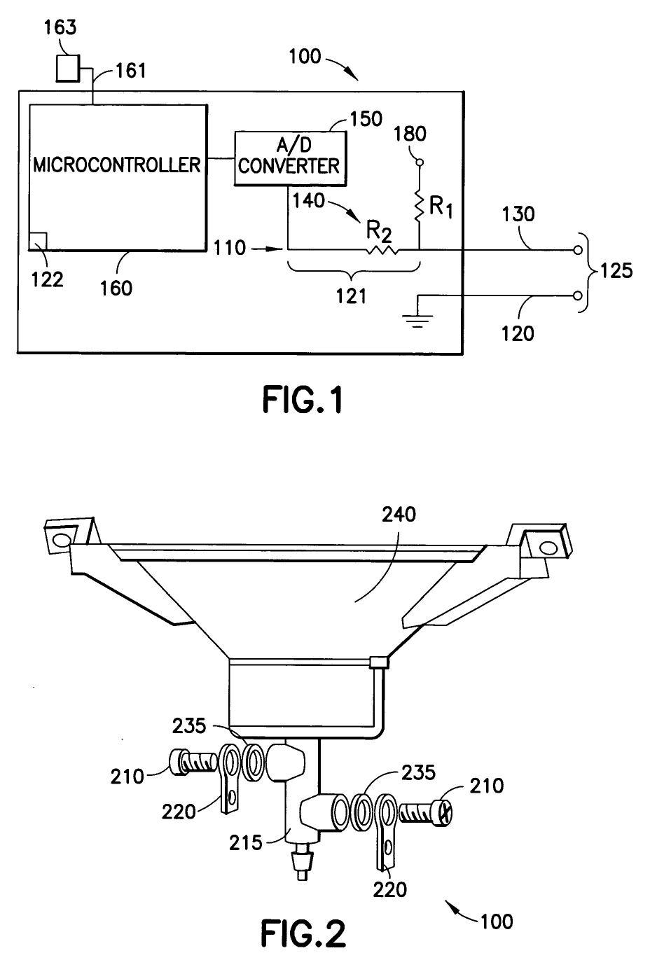

Referring to FIG. 1, a schematic block diagram of an embodiment of the present invention is shown. A liquid presence sensor system 100 of the invention includes a circuit 110, to detect the presence of fluid in an ultrasonic product. Preferably, circuit 110 is coupled to a logic unit 160 for controlling the operation of the circuit 110. The liquid presence sensor system 100 may form a part of an apparatus such as an ultrasonic cleaning system or any system that uses ultrasonic acoustic energy.

An input voltage, Vᵢₙₚᵤₜ, is applied at input voltage point 180 by a voltage source. Preferably, Vᵢₙₚᵤₜ is a DC voltage signal which is constantly applied over periods of time during which the presence of fluid is to be monitored. In other advantageous embodiments, discussed more fully below, Vᵢₙₚᵤₜ may be a pulsed DC signal or an AC signal.

Circuit 110 is additionally formed of a first and second electrode 130, 120 respectively, wherein second electrode 120 is coupled to a common circuit point, preferably ground. First and second electrodes 130, 120 are separated by fluid gap 125. Fluid gap 125 forms an expanse capable of being bridged by a continuum of fluid. In the absence of fluid, fluid gap 125 causes circuit 110 to act as an open circuit. As a result, current does not flow between the electrodes 130, 120. When fluid is present within fluid gap 125 and between the electrodes 130, 120, the fluid acts like a resistor of relatively high value connected between the electrodes 130, 120. This fluid resistance, R_{fluid}, is typically approximately 200K ohms. In such an instance, current flows from input voltage point 180 across resistor R₁, along electrode 130, across the fluid, and along electrode 120 to a common circuit point, typically ground. As the current flows, a voltage differential arises across resistor R₁ and the voltage sensed at junction 140 is less than Vᵢₙₚᵤₜ.

R₁, therefore, acts a voltage divider creating a measurable drop in voltage from Vᵢₙₚᵤₜ to be measured, or otherwise sensed, at junction 140. When the input voltage 180 is a DC signal designated as Vᵢₙₚᵤₜ and electrode 120 is connected to ground, the voltage present at junction 140 is approximately equal to Vᵢₙₚᵤₜ*(R₁/(R₁+R_{fluid}). As is evident, R₁ may be chosen to produce a voltage at junction 140 within a chosen range.

Voltage sensor 121 operates to sense, or otherwise measure, the voltage at junction 140. Voltage sensor 121 includes an electrically conductive portion, typically a wire with a high resistance R₂. R₂ is chosen to have a value high enough to prevent unwanted current leakage from the circuit 110 into A/D converter 150 and logic unit 160. Voltage sensor 121 communicates the value of the voltage sensed at junction 140 for use in determining the presence or absence of fluid between electrodes 130, 120.

In a preferred embodiment, voltage sensor 121 communicates the voltage at junction 140 as an input to an A/D converter 150. A/D converter 150 converts the input to a digital representation of the voltage sensed at junction 140. The digital representation is outputted by the A/D converter and forms the input to logic unit 160. Logic unit 160 is preferably a microprocesor capable of receiving a digital input, performing logical operations upon the input, an outputting a signal in response thereto. Preferably logic unit 160 operates to compare the inputted voltage value at junction 140, communicated via A/D converter 150, to a threshold value 122.

The threshold value is chosen such that, if the inputted voltage value at junction 140 is at or below the threshold value, current is deduced to be flowing between the electrodes 130, 120 in an amount indicative of the presence of fluid between the electrodes 130, 120. The fluid path, described more fully below, is designed such that residual fluid will drain from between the electrodes when all available fluid has been dispensed.

For example, if R₁ is chosen to be 200K ohms, R_{fluid} is 200K ohms, and Vᵢₙₚᵤₜ is 5V, the voltage measured at junction 140, in the presence of fluid between electrodes 130, 120 is approximately 2.5V. A threshold value of, for example, 4V would serve to indicate, by way of comparing the voltage at junction 140 to the threshold voltage, that fluid is present between electrodes 130, 120. As is evident, while the values of R_{fluid}, R₁, and Vᵢₙₚᵤₜ, may vary, a threshold value can be selected that is sufficient for use in determining the presence of fluid between the electrodes 130, 120. Preferably, the threshold value 122 is stored in a manner so as to be retrievable by logic unit 160. As will be described below, threshold value 122 may also be capable of being modified by logic unit 160.

Logic unit 160, in addition to determining the presence of or absence of fluid between the electrodes 130, 120, outputs a control output signal 161. Control output signal 161 may be utilized to control the operation of a device in which sensor system 100 operates or with which sensor system 100 is in communication. Preferably, in the context of a sensor system 100 operating to control the operation of a cleaning system, in particular an acoustic or ultrasonic cleaning system, the transmission of ultrasonic or acoustic energy is halted when there is sensed to be an absence of fluid between the electrodes 130, 120. In addition, control output signal 161 may be utilized to operate an indicator 163. Indicator 163 may be a visual indicator, such as an LED or other light emitting construct, an audio indicator, such as a buzzer or other emitter of acoustic energy, and/or a sensory indicator, such as a vibration producing construct. Indicator 163 operates to indicate, preferably to a user of a device in which, or with which, sensor system 100 operates that fluid is either present or absent.

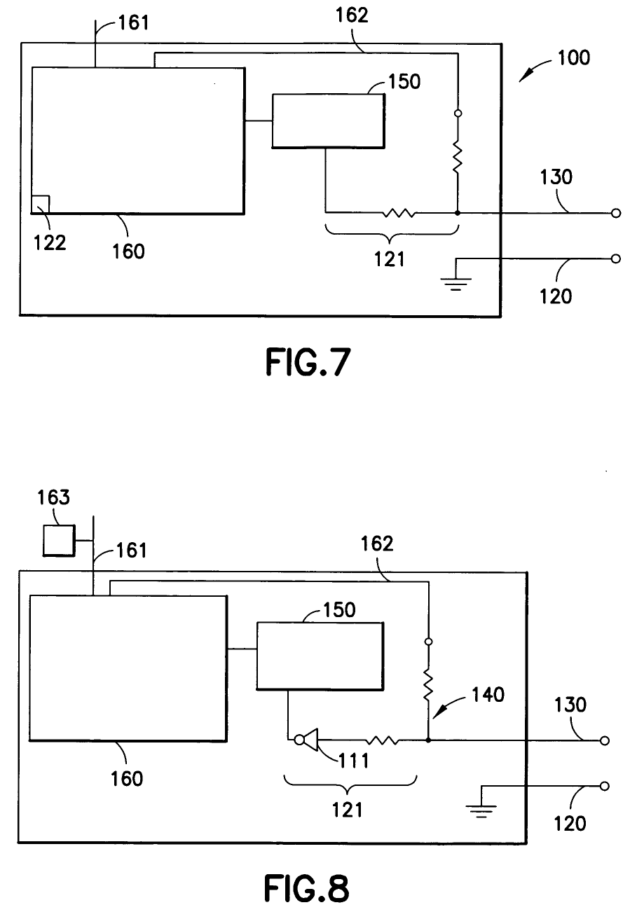

With respect to FIG. 7, there is illustrated an alternative embodiment of the sensor system 100. In addition to control output signal 161, voltage output signal 162 is outputted from logic unit 160. Voltage output signal 162 operates to provide Vᵢₙₚᵤₜ. Logic unit 160 may be configured to repeatedly send pulses of Vᵢₙₚᵤₜ and to sense the presence or absence of fluid in synchronicity with the pulsed Vᵢₙₚᵤₜ signals. In addition to generating voltage output signal 162 of a particular value, threshold value 122 may be altered as required to facilitate the determination of the presence of fluid.

With reference to FIG. 8, there is illustrated an alternative embodiment of the sensor system 100 of the invention. As illustrated, voltage output signal 162 is an A/C signal. In such a configuration, the presence of fluid between the electrodes 130, 120 results in the receipt at A/D converter 150 of a sinusoidal signal. A diode 111 is incorporated into voltage sensor 121 to clip the negative portion of the sinusoidal signal. Preferably, the sinusoidal voltage signal 162 is outputted from logic unit 160. Use of a sinusoidal Vᵢₙₚᵤₜ signal results in the repeated switching of the polarity of electrodes 130, 120. Such an alteration of polarity serves to avoid the accumulation of corrosion on the electrodes.

While described with reference to a microprocessor based logic unit 160 and A/D converter 150, both components may be implemented, separately or in combination, as a collection of logic chips and comparators arranged to compare a provided or otherwise generated threshold voltage to a voltage sensed at junction 140 and to output a signal indicative of the desired operation of a device with which sensor system 100 is in communication.

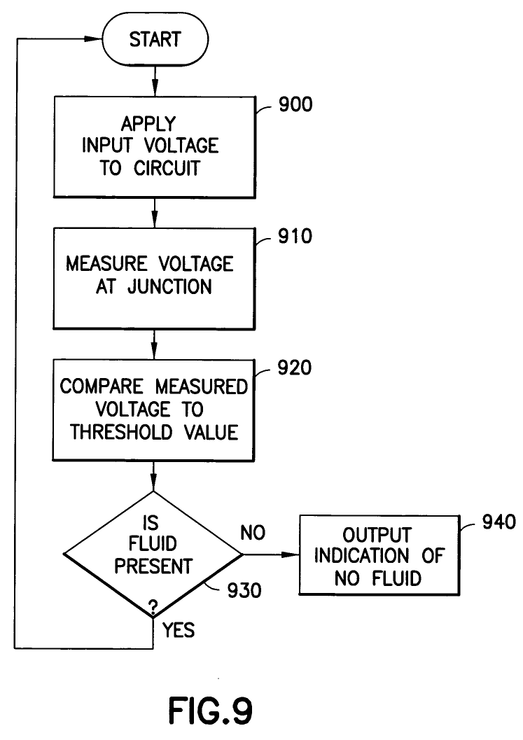

With reference to FIG. 9, there is illustrated a flow chart of the methodology of the invention. At step 900, an input voltage, Vᵢₙₚᵤₜ, is applied to circuit 110. The voltage at junction 140 is subsequently measured, or otherwise sensed, at step 910. The measured voltage is compared to a threshold voltage at step 920. A determination is made based upon the results of the aforementioned comparison as to whether fluid is present at step 930. If fluid is found to be present, the method begins again at step 900. If no fluid is found to be present, the device in which, or with which, circuit 110 is operating is alerted at step 940 to the absence of fluid 940. In response, indication may be provided that fluid is absent and/or the operation of the device may be halted.

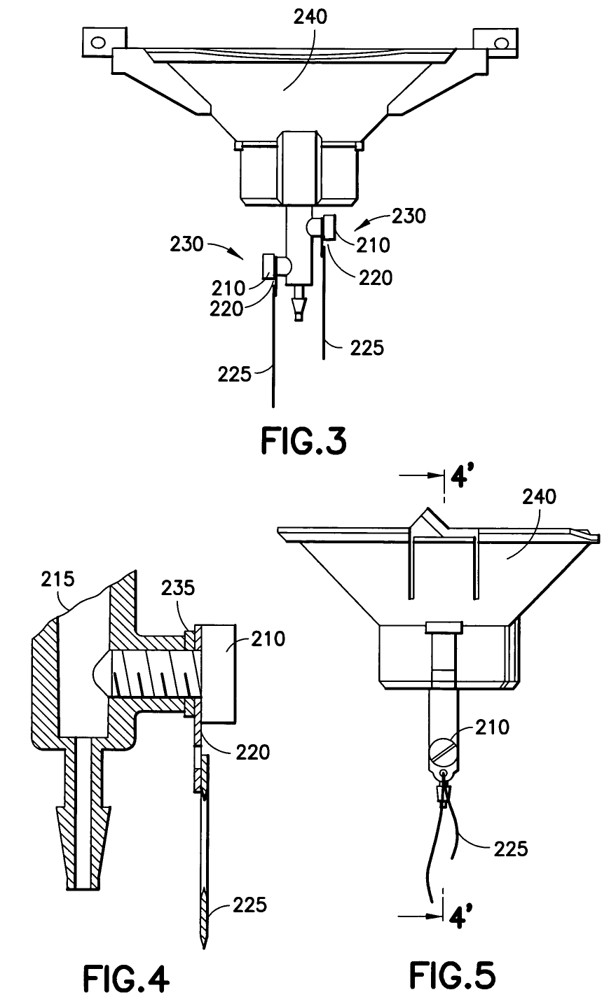

Referring now to FIG. 2, in conjunction with FIG. 3, there is illustrated an exemplary embodiment of a portion of the sensor system 100. The sensor system 100 preferably includes two small, gold-plated screws 210 inserted crosswise into a preferably 0.15″ diameter cylindrical channel 215. Under the head of each of these two screws 210 is a solder terminal 220 soldered to a wire 225 and a sealing ring 235. The sensing points 230 are spaced at approximately 3/4 inch. The two wires 225 connect to the two fluid sensing electrodes 120, 130 shown in FIG. 1. In this manner, the fluid gap 125 of FIG. 1 extends across cylindrical channel 215 forming a fluid path. The channel 215 is mounted approximately 45 degrees off vertical so that the channel 215 will drain properly, whether the appliance is sitting on a horizontal surface, or is mounted vertically. For proper operation, fluid in the sensor preferably drains by gravity.

The resistance of the conductive cleaning fluid (not shown) within the cylindrical channel 215 is measured by the circuit of FIG. 1. When the channel 215 is empty, the resistance is nearly infinite. When the channel 215 is full, there is a high, but measurable resistance present across the fluid.

There is a pump (not shown) downstream of the sensor system 100. The sensing screws 210 are mounted in a staggered configuration, rather than directly across from one another. The volume of fluid being sensed is contained within an area of the channel 215 roughly 3.5 mm diameter by 12 mm long. The resistance of the target fluid within this channel 215 is approximately 200K ohms.

Referring now to FIG. 4, a cross sectional view of a portion of the liquid presence sensor system is shown, taken along line 4′-4′ of FIG. 5. The sensor assembly includes two sensor screws 210 with gold-plated terminals 220, seal rings 235 and lead wire 225. FIG. 5 shows a side view of the liquid presence sensor system shown in FIG. 3.

As described above, when there is fluid flow inside the housing interface 240, two sensing screws 210 will short together via the fluid. This will result in a measurable conductivity to the output of the sensor system 100. When there is no fluid flow inside the housing interface 240, the two sensing screws 210 cannot be shorted together as there is only isolated air between them. This will result in poor conductivity to the output of the sensor system 100, indicative of the absence of fluid.

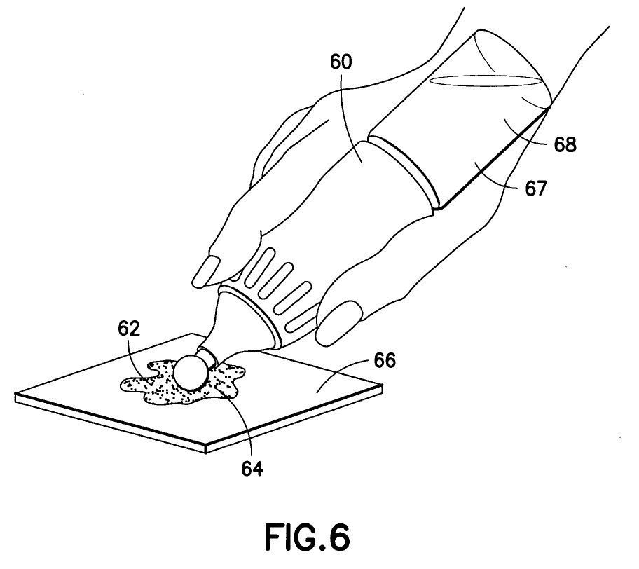

Referring now also to FIG. 6, a cleaning device 60 is shown incorporating features of the invention. The cleaning device 60 is similar to the cleaning device described in U.S. Pat. No. 6,376,444 B1, which is hereby incorporated by reference in its entirety. In this embodiment, the cleaning device 60 is in the form of a hand-held wand with a vibrating, smooth (e.g., spherical) sonic horn or tip at one distal end 62 of the device 60. The stain 64 on an article 66, such as textile, has the cleaning composition applied to it and then is subjected to sonic or ultrasonic waves using the device 60. In this embodiment, the cleaning device 60 comprises a reservoir 68 which holds a liquid cleaning composition or fluid. The fluid 67 travels from reservoir 68 into housing interface 240 (not shown) and onto article 66.

The stain removal product preferably includes instructions for using the product which comprises the steps of: applying an effective amount of the liquid cleaning composition to the stain; imparting sonic or ultrasonic waves to the stain using the sonic or ultrasonic source; and contacting the absorbent stain receiver with the stain while applying pressure so as to absorb the stain into the absorbent material of the absorbent stain receiver. The phrase “effective amount” means an amount of the composition sufficient to saturate the stain, and will typically include applying from about 0.5 ml to about 3 ml of the composition for a small stain (e.g., less than 1 cm in diameter). This amount can vary if the stained area is very large, for example, on a large area of a garment in which case much more of the composition will be needed to saturate the stained area. An effective amount is therefore dependent upon the stain size. It is preferable for the stain to be thoroughly saturated with the cleaning composition such that the soils that have been dislodged by the sonic or ultrasonic waves can be effectively suspended in the composition. In this way, the absorbent stain receiver can absorb all of the soils embodied in the stain via absorption of the cleaning composition.

In another process of using the stain removal product, the stain removal may include instructions for using the product comprising the steps of using the device to apply an effective amount of the liquid cleaning composition to the stain concurrently with sonic or ultrasonic waves from the sonic or ultrasonic source contained in the device; and contacting the absorbent stain receiver with the stain while applying pressure so as to absorb the stain into the absorbent material of the absorbent stain receiver. The pressure is applied by the user's hand in the z direction (i.e., normal to the plane of the fabric being cleaned) and preferably not in the x and/or y directions so as not to cause wear and tear on the material that has been stained. As shown in the FIG. 6, the process is facilitated by using a device 60 such that the composition and the sonic or ultrasonic waves are applied simultaneously to permit controlled dispensing of the liquid cleaning composition to the stain.

Another embodiment of the invention contains the absorbent stain receiver having an absorbent material which is imbibed with a liquid cleaning composition including water, an organic solvent and a surfactant, and a sonic or ultrasonic wave generating source for imparting sonic or ultrasonic waves onto stains on textiles. In this product form, the preferred absorbent material is a Functional Absorbent Material (“FAM”) foam. The process of using this product entails contacting an absorbent stain receiver with the stain, wherein the absorbent material is imbibed with a liquid cleaning composition including water, an organic solvent and a surfactant. The stain receiver can be applied underneath the stained fabric, or alternatively, on top of the stain. Thereafter, pressure is applied by forcing the sonic or ultrasonic device directly against the absorbent stain receiver (in the case of the stain receiver being applied on top of the stained fabric) such that the liquid cleaning composition is forced from the absorbent material into the stain. In the case of the stain receiver being positioned underneath the stain, pressure is applied by pressing the device directly against the stain, which in turn, presses against the stain receiver forcing the cleaning composition into the stain. Sonic or ultrasonic waves from a wave generating source is imparted to the stain, and in both stain receiver positions, the applied pressure is relieved such that the liquid cleaning composition and the stain are absorbed back into the absorbent material in the absorbent stain receiver. This technique allows the cleaning treatment to be localized, thereby minimizing treatment of non-stained areas of the textiles which unnecessarily can increase wear and tear on the stained article.

In a preferred mode of operation, the pressure and sonic or ultrasonic wave application steps are conducted using a pen-shaped, hand-held vibrational sonic or ultrasonic device with a vibrating smooth, rounded (e.g., spherical) sonic horn or tip at one distal end of the device which can be pressed in the z direction against the stain and simultaneously impart the sonic or ultrasonic waves to the stain. The sonic or ultrasonic device can be used directly against the stain with the absorbent stain receiver positioned underneath the stained textile so that the liquid cleaning composition is drawn from the opposition side of the sonic or ultrasonic waves as pressure is applied. Alternatively, the absorbent stain receiver can be contacted with the stain using the sonic or ultrasonic device which is pressed against the stain receiver, which in turn, presses against the stain drawing liquid cleaning composition into the stain. The sonic or ultrasonic waves penetrate through the stain receiver and to the stain, after which the sonic or ultrasonic device is lifted away releasing the pressure such that both the stain and liquid cleaning composition are wicked or absorbed back into the stain receiver.

A variety of sonic or ultrasonic sources can be used in the invention including, but not limited to, sonic cleaning baths typically used to clean jewelry and sonic toothbrushes for cleaning teeth. One suitable sonic or ultrasonic source is a modified sonic toothbrush in which the head of the sonic toothbrush is replaced with a smooth chrome spherical tip as shown in the FIG. 6. Features of the present invention could be used in a toothbrush. Other tip modifications can be made without departing from the scope of the invention so long as the tip structure preferably does not have a structure which can abrade the article with which it comes into contact. Typically, from about 1 watt to about 5 watts, more typically from about 2 watts to about 3 watts, of ultrasonic amplitude is sufficient to treat garments and the like.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. For example, the circuit could be adapted to sense the presence of other substances, including liquids, powders, and pellets. Another voltage measuring device or an analog comparator can substitute for the measuring device. A constant current source or other device can substitute for the resistor. The reference device and the fluid channel can return to points other than a voltage source or to circuit common. More than two electrodes could be implemented. As was noted above, the system in accordance with this invention may include an ultrasonic cleaning system or other ultrasonic based system wherein detecting the presence or absence of fluid is desired. However, all such and similar modifications of the teachings of this invention will still fall within the scope of this invention.

1. A system for detecting a presence of a liquid in an ultrasonic frequency device comprising:
a first electrode coupled to a voltage source and extending into a fluid reservoir of said ultrasonic device;
a second electrode separated from said first electrode by a fluid gap, coupled to a common circuit point, and extending into said fluid reservoir;
a first resistor in series with said voltage source and said first electrode;
a voltage sensor coupled to a junction between said first resistor and said first electrode for sensing a voltage at said junction; and
a system for comparing said sensed voltage to a threshold voltage to determine a presence of a fluid within said fluid reservoir.

2. The system of claim 1 wherein said system for comparing comprises a logic unit.

3. The system of claim 2 wherein said logic unit comprises a microprocessor.

4. The system of claim 3 additionally comprising an A/D converter receiving as an input said sensed voltage and outputting a digital representation of said sensed voltage to said microprocessor.

5. The system of claim 1 wherein said system for comparing provides said voltage source.

6. The system of claim 1 wherein said voltage source comprises a signal selected from the group consisting of a DC signal, an AC signal, a pulsed DC signal, and a pulsed AC signal.

7. The system of claim 1 wherein said ultrasonic frequency device is a cleaning device.

8. The system of claim 1 wherein said system for comparing comprises a comparator.

9. The system of claim 1 additionally comprising an indicator for indicating said presence of said fluid.

10. The system of claim 9 wherein said indicator is selected from the group consisting of a visual indicator, an audio indicator, and a sensory indicator.

11. The system of claim 1 wherein said system for comparing comprises said voltage source.

12. A cleaning apparatus comprising:
a reservoir for holding a cleaning fluid;
a system for dispensing an amount of said cleaning fluid;
a system for emitting an ultrasonic signal at said dispensed cleaning fluid; and
a system for detecting a presence of said cleaning fluid in said reservoir.

13. The cleaning apparatus of claim 12 wherein said system for detecting comprises:
a first electrode coupled to a voltage source and extending into said reservoir;
a second electrode separated from said first electrode by a fluid gap, coupled to a common circuit point, and extending into said reservoir;
a first resistor in series with said voltage source and said first electrode;
a voltage sensor coupled to a junction between said first resistor and said first electrode for sensing a voltage at said junction; and
a system for comparing said sensed voltage to a threshold voltage to determine a presence of said cleaning fluid within said reservoir.

14. The cleaning apparatus of claim 13 wherein said system for comparing comprises a logic unit.

15. The cleaning apparatus of claim 14 wherein said logic unit comprises a microprocessor.

16. The cleaning apparatus of claim 15 additionally comprising an A/D converter receiving as an input said sensed voltage and outputting a digital representation of said sensed voltage to said microprocessor.

17. The cleaning apparatus of claim 13 wherein said system for comparing provides said voltage source.

18. The cleaning apparatus of claim 13 wherein said voltage source comprises a signal selected from the group consisting of a DC signal, an AC signal, a pulsed DC signal, and a pulsed AC signal.

19. The cleaning apparatus of claim 13 wherein said system for comparing comprises a comparator.

20. The cleaning apparatus of claim 12 additionally comprising an indicator for indicating said presence of said cleaning fluid.

21. The cleaning apparatus of claim 20 wherein said indicator is selected from the group consisting of a visual indicator, an audio indicator, and a sensory indicator.

22. The cleaning apparatus of claim 13 wherein said system for comparing comprises said voltage source.

23. A method for operating an ultrasonic frequency device comprising:
providing an ultrasonic frequency device having a fluid reservoir extending between a first and a second electrode;
applying a voltage across said first and second electrode;
measuring a voltage at a junction formed between a resistor and said first electrode said resistor in series with a source of said applied voltage;
comparing said measured voltage to a threshold value to determine a presence of a fluid in said ultrasonic frequency device; and
controlling the operation of said ultrasonic frequency device in response to said determination of said presence of said fluid.

24. The method of claim 23 wherein said controlling comprises providing an indicator of said determination of said presence of said fluid.

25. The method of claim 24 wherein said indicator is selected from the group consisting of audio indicator, visual indicator, and sensory indicator.

26. The method of claim 23 wherein said supplying said voltage comprises applying a signal selected from the group consisting of a DC signal, an AC signal, a pulsed DC signal, and a pulsed AC signal.
